(19) United States
(12) Patent Application Publication
(10) Pub. No.: US 2002/0120626 A1
(43) Pub. Date: Aug. 29, 2002

(54) Indexing network-resident objects

(75) Inventor: Michael P. Wegener, Boulder, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Zulaware, Inc., Boulder, CO

(21) Appl. No.: 10/066,327

(22) Filed: Jan. 30, 2002

Related U.S. Application Data
(60) Provisional application No. 60/265,259, filed on Jan. 31, 2001.
(60) Provisional application No. 60/297,375, filed on Jun. 11, 2001.
(60) Provisional application No. 60/352,008, filed on Jan. 23, 2002.

(51) Int. Cl. G06F 7/00; G06F 17/30

(52) U.S. Cl. 707/10; 707/3

(57) ABSTRACT

According to the invention, a method for providing search results for network-resident objects to a user is disclosed. In one step, a plurality of search processes are monitored. Information relating to the plurality of search processes is stored. A search query from the user is received. The search query is correlated with the information relating to plurality of search processes. Search results related to the search query and the information are presented.

This application claims the benefit of and is a non-provisional of Provisional Application No. 60/265,259 filed on Jan. 31, 2001; Provisional Application No. 60/297,375 filed on Jun. 11, 2001; and Provisional Application No. ______ (denoted by Attorney Docket 20319-000500 until the application number is known) filed on Jan. 23, 2002, which are all incorporated herein by reference in their entirety.

### BACKGROUND OF THE INVENTION

This invention relates in general to network search engines and, more specifically, to indexing network-resident objects.

Information retrieval systems generally fall into two categories: search engines and directories. Search engines process documents prior to the search process via an algorithm-driven method and indexes them in a searchable database. Directories classify documents prior to the search process via either human review or an algorithm driven computer program either of which then indexes them by a human-generated hierarchy. Search engines and directories both need to make finding information on a network an easier process.

### BRIEF DESCRIPTION OF THE DRAWINGS

The present invention is described in conjunction with the appended figures:

FIG. 1 is a block diagram of an embodiment of software components for the present invention;

FIG. 2 is a flow diagram of an embodiment of a cyclical search process;

FIG. 2a is a flow diagram of a linear, generalized method for information retrieval found in the prior art;

FIG. 3 is a flow diagram of an embodiment of a process that shows how a model of the user's search path is built; and

FIG. 4 is a block diagram of an embodiment of a search path model.

In the appended figures, similar components and/or features may have the same reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

The present invention provides an improved way to index information residing on a network. As users search for information, their actions are observed to determine what proved to be good results for each of them. Those results are stored and analyzed to provide more relevant future search results to other users. In some embodiments, the user is asked for feedback on whether the search results proved useful.

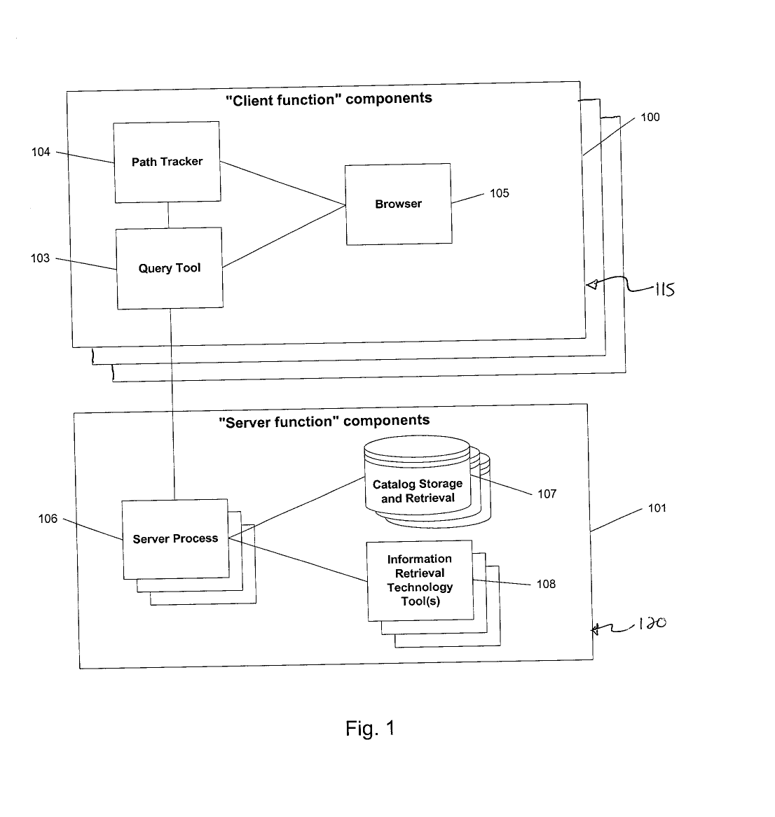

Referring first to FIG. 1, illustrated is the present invention embodied as software consisting of several components in an abstracted client-server configuration. Client function components 100 include software components associated with the user interface. In this embodiment, there are a number client function components 100 coupled to server function components 101. The client components 101 can be independently located on a client machine(s) 115, a server machine 120, or remote to one or both. The server function components 101 include software components that broker user processes for data retrieval and storage. The server components 101 can also be independently located on the client machine(s) 115, the server machine 120, or remote to both.

A query tool 103 provides an interface which allows formation of simple and complex queries via arbitrary means of entry or any logical data construction, i.e. keywords, Boolean, form-based, etc., and facilitates the display of interactive data elements. The path tracker 104 records the queries, any viewed results and any followed hyperlinks by integrating with a web browser 105 and the query tool 103.

In this embodiments, the query tool 103 and browser 105 have a client-side graphical interface. A client-side graphical interface is optional and not necessary for the path tracker 104. The browser 105 and path tracker 104 may be implemented as stand-alone or integrated third-party software components. The query tool 103 may be implemented as any combination of executable, byte code, scripting or markup language components, or integrated within another application.

A server process 106 facilitates client connections to various data sources, and can either pre- or post-process query data from the query tool 103. A catalog storage and retrieval database 107 is a physical storage of index data produced by the present invention. Information retrieval technology tools 108 can be any proprietary or public information retrieval tool that has an external (non-user) interface network resident objects, i.e. search engines, directories, databases, etc.

In the following descriptions, we use the term “document” to generically name any network-accessible digital file, i.e. HTML document, text file, audio file, image file, video file, etc. and more specifically, any arbitrary, addressable point or section within that file.

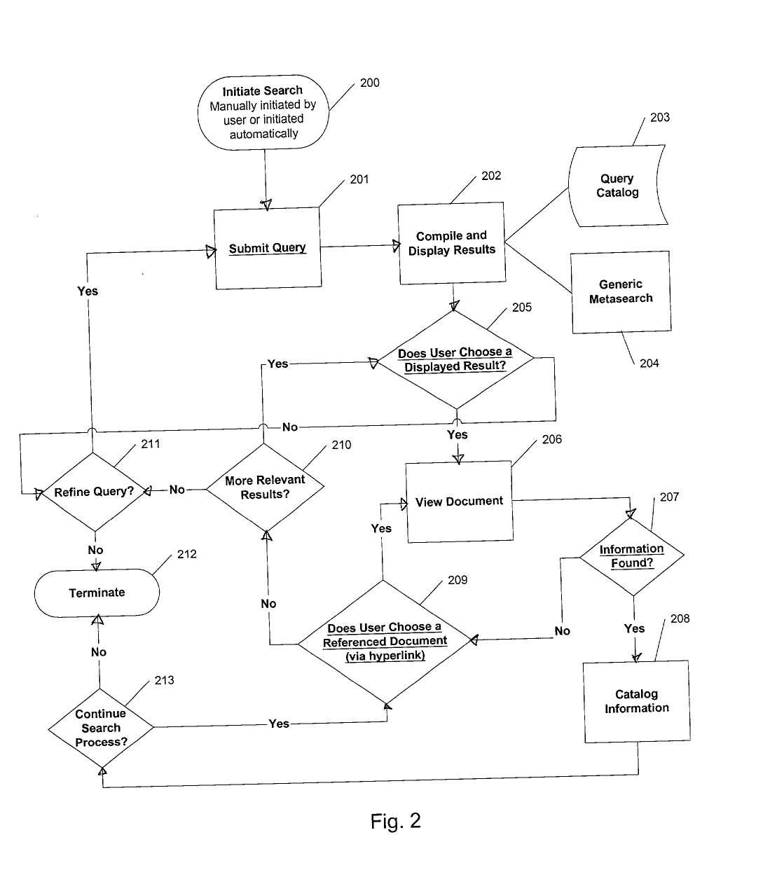

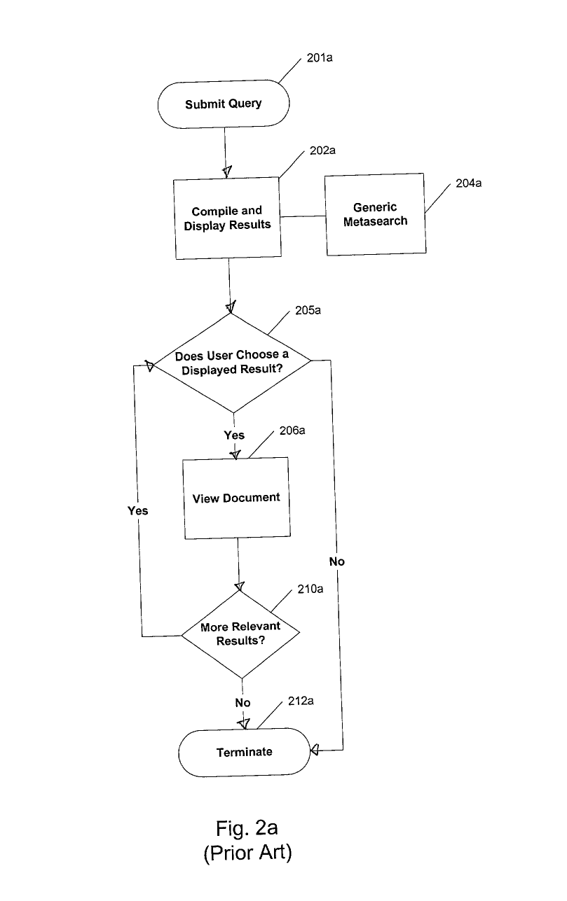

FIG. 2 illustrates an embodiment of a search process that is integrated with the present invention. In this diagram, several steps are underlined, to signify that they are actions taken by the user and are compiled in a symbolic and logical path. These paths are analyzed, summarized and stored through various methods. These steps further illustrate how the present invention differs from existing, comparable information retrieval systems, and where the data representing user experience are derived to populate the catalog 107.

Also illustrated is the cyclical nature of the present invention as it is integrated into the query process (steps 201, 202, 205-207, 209-211) as well as the unique step 209 that introduces the ability to follow users arbitrarily through any browseable, viewable or searchable domain. In other words, step 209 enables unlimited “deep web” or “invisible web” indexing.

Step 200 is a logical starting point for an atomic, contiguous search, defined as an initial query of arbitrary form (i.e. text keywords, Boolean, interface-driven, etc.) terminated by the location of qualified information that answers that initial query or any of subsequent query refinements. Within this atomic, contiguous search can exist any number of document views or query refinements. Step 200 is either explicitly initiated by the user (e.g., a “New Search” command) or is implicitly initiated by automated detection of user actions (e.g., submitting a web form, entering all new query terms, etc.).

Step 201 is where the user supplied search criteria from a new or revised query are processed for retrieval. Step 201 is initiated by user action, but can be integrated with step 200 for new searches. Step 202 compiles the formats the results from steps 203 and 204. The catalog 107 of step 203 is the repository of index data. In step 204, any arbitrary number of information retrieval system queries are performed. In step 205, a determination is made as to what action represents a user takes upon a displayed, actionable (i.e. hyperlinked, keyboard shortcut, etc) result from step 202. Step 206 displays the selected document and assumes the user reviews the information.

Step 207 is an explicit (e.g. user clicking interface button, etc.) and/or implicit (e.g. user starts new search, etc.) acknowledgement by the user that the search was judged to be successful. Step 208 initiates the storage of correlated query and document data with an arbitrary and optional amount of corresponding metadata and statistical data in the catalog 107. In step 213, the user may follow a link in the document by going to step 209 or may terminate the search in step 212.

Step 209 illustrates a situation where a user may seemingly arbitrarily follow hyperlinks or symbolic links within viewed documents, and that the present invention tracks these actions to derive value from them. Step 210 signifies a judgment by the user whether there is still value in exploring more of the results displayed in step 202. Step 211 signifies a judgment by the user that more value will be derived from the process by looping back to step 201 to refine and/or reformulate the query. Step 212 is an explicit or implicit decision by the user to quit the current, atomic, contiguous search.

FIG. 2a is a conventional information retrieval system that illustrates the linear nature of the process that does not derive value from user experience. Step 201a is the initial query submission, which is usually via text description (keywords) input via a web page form or other user interface. Step 202a creates the display of the returned query results derived through step 204a, which consists of one or more arbitrary information retrieval methods. From step 205a, the user may view the document in step 206a or terminate the search in step 212a.

Step 206a signifies user review of the document. Step 210a signifies a judgment by the user whether there is still value in exploring more of the results displayed in step 202a. Step 212a represents an implicit end of search. Steps 205a, 206a and 210a are the human experience of searching for information.

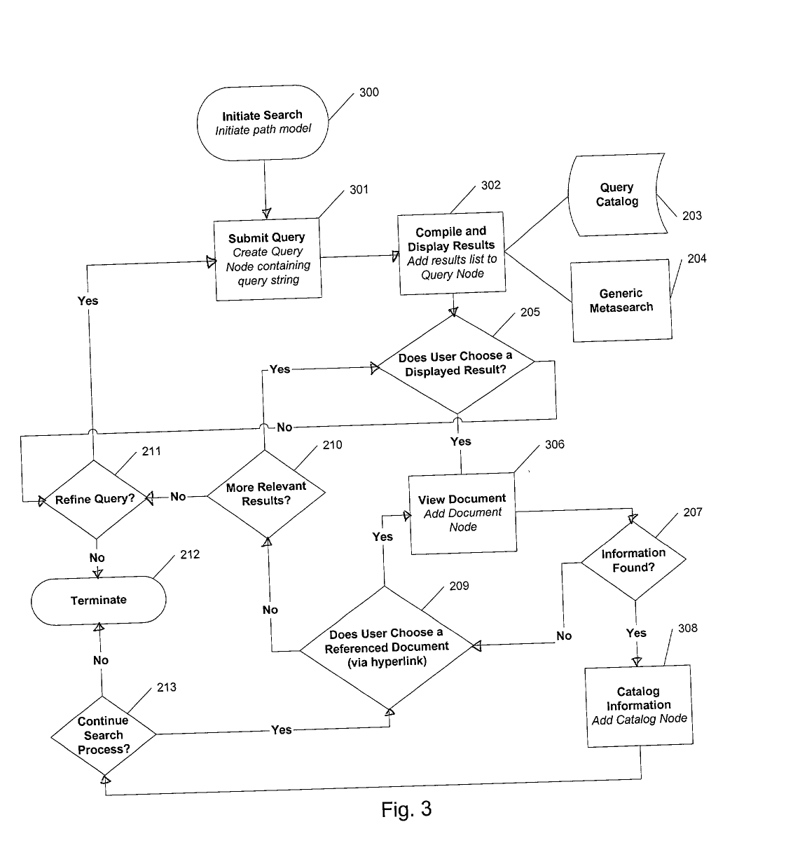

FIG. 3 is a flowchart depicting how the client-server system builds a model of the user's search path. The models of users' successful search paths are stored and analyzed, as they encapsulate the human experience of finding valuable information, from which human-qualified indexing, statistical and metadata information can be derived. FIG. 3 is similar to FIG. 2, as the path information is derived from user actions within the search process described in the present invention. Modified steps beyond those in FIG. 2 are indicated for clarity with italicized text. Primarily, those so marked modified steps are described here.

Step 300 is a logical starting point for an atomic, contiguous search, with initiation conditions as in step 200 above. When an initial query is prepared by the user and submitted in step 301, a query node is created and added to the path model. When the initial results are returned, and when any subsequent results are returned in step 302, they are added to the originating query node.

In step 306, each document viewed by the user within the search process is added as a document node to the current query node if it is selected from a results list, or to the current document node, if the user followed a symbolic link within that document to reach the viewed document. Step 308 marks the successful conclusion of a search path, and marked with a catalog node. The user can either continue with the same search criteria, start a new search, or exit.

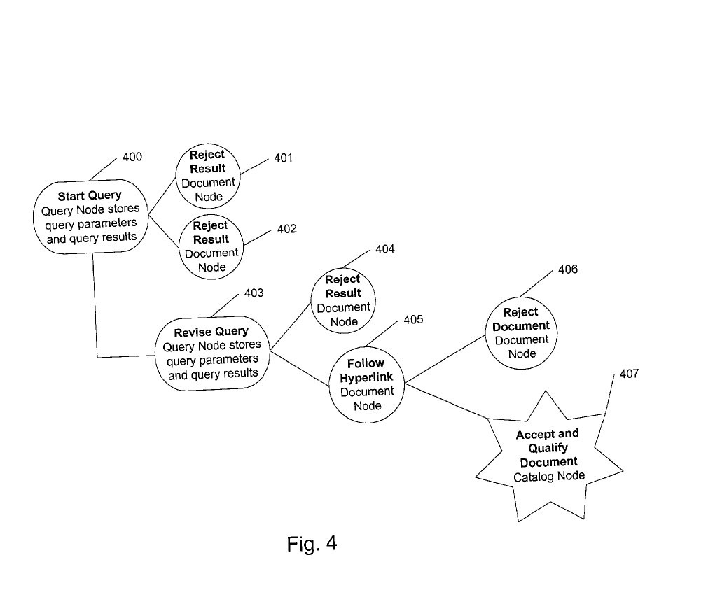

FIG. 4 is a block diagram illustrating an example search path produced by a particular set of user actions through the process depicted in FIG. 3. It includes of a series of branched nodes, labeled by the user action that created the node in bold type and the type of node as referenced in FIG. 3 description above. This diagram will reference the step numbers of FIG. 3 that create individual nodes. A successful search is defined as a path originating with an initial query and ending with a cataloged correlation of query to document. Any arbitrary number of arbitrarily branched query revisions, viewed documents and cataloged data can be contained within a successful search.

Start query 400 is created by the user formulating a query in step 301 and the results data returned are added in step 302. Reject result 401 is created by the user selecting one of the displayed results, but not finding the sought for information. Similarly for Reject Result 402 and 404. Revise Query 403 is created when the query formulation is changed by the user in step 301 when traversing from step 311. The user rejects one result in this example (i.e., Reject Result 404), then follows a hyperlink contained in another result (i.e., Follow Hyperlink 405) as in step 306 traversing from step 309. Reject Document 406 is created similarly as Reject Result 401, but originating from a hyperlink or symbolic link contained in an arbitrary document as opposed to query results. Accept and Qualify Document 407 is produced in step 308 when a user has explicitly or implicitly signaled that satisfactory information has been located for a particular query.

While the principles of the invention have been described above in connection with specific apparatuses and methods, it is to be clearly understood that this description is made only by way of example and not as limitation on the scope of the invention.

What is claimed is:

1. A method for providing search results for network-resident objects to a user, the method comprising steps of:
monitoring a plurality of search processes;
storing information relating to the plurality of search processes;
receiving a search query from the user;
correlating the search query with the information relating to plurality of search processes; and
presenting search results related to the search query and the information.

2. The method for providing search results for network resident objects to the user as recited in claim 1, wherein the information includes search terms.

3. The method for providing search results for network-resident objects to the user as recited in claim 1, wherein the information includes hyperlinks selected in the plurality of search processes.

4. The method for providing search results for network-resident objects to the user as recited in claim 1, wherein the information includes answers to questions posed to those performing the plurality of search processes.

5. The method for providing search results for network-resident objects to the user as recited in claim 1, further comprising a step of posing a question to one or more of those performing the plurality of search processes, wherein the question relates to a quality of search results from a respective one of the search processes.

6. A computer-readable medium having computer-executable instructions for performing the computer-implementable method for providing search results for network-resident objects to the user as recited of claim 1.
